(19) United States
(12) Patent Application Publication
(10) Pub. No.: US 2012/0111884 A1
(43) Pub. Date: May 10, 2012

(54) Automatic soap dispenser with notification function

(76) Inventor: CHUN KWONG CHOI, Fo Tan (HK)

(21) Appl. No.: 12/909,819

(22) Filed: Oct. 21, 2010

(51) Int. Cl. B67D 7/08

(52) U.S. Cl. 222/52; 222/642; 222/333

(57) ABSTRACT

The present invention is an automatic soap dispenser with notification function, which comprises an outer casing; a soap container; a plunger driven by a plunger driving means to move up and down between a default position and a dispensing position where the pump dispensing means is depressed to dispense liquid soap; a plunger position sensor which is configured to be triggered when the plunger is at the default position; and an integrated circuit with timing function which is programmed to operate in such a way that when the user sensing means is triggered, the integrated circuit activates the plunger driving means and initiates the timing function in order to activate the notification means after a predetermined period of time has elapsed, and when the plunger position sensor is triggered, the integrated circuit deactivates the plunger driving means.

### BACKGROUND OF THE INVENTION

The present invention relates to a soap dispenser and more particularly pertains to a soap dispenser that dispenses soap automatically upon detection of user presence and provides timing and notification functions.

Soap dispensers known and used within the art can be categorized into manual and automatic soap dispensers. Manual soap dispensers normally require the user to press the pump dispenser of the soap container by hand in order to dispense liquid soap. Automatic soap dispensers are normally installed with sensors such as infrared sensors to detect user's hands and dispense soap automatically when the hands are in close proximity. In comparison with manual soap dispensers, automatic soap dispensers do not require users to touch the soap container and thereby reducing the chances of dirtying the hands or spreading germs.

It is recommended by the Centers for Disease Control and Prevention that hands should be rubbed together with soap for 10 to 15 seconds for the hands to be cleaned thoroughly. However, many people are not aware of this and they usually fail to thoroughly clean their hands, thus creating opportunities for germs to spread. Some people know clearly the correct period of time required for rubbing their hands together with soap, but as automatic soap dispensers in the art are not provided with timing and notification functions, they could not measure the time precisely when they are washing hands and therefore fail to thoroughly clean their hands.

### BRIEF SUMMARY OF THE INVENTION

In view of the aforesaid disadvantages now present in the prior art, the present invention provides an automatic soap dispenser that automatically detects user presence and alerts the user of the correct period of time required for rubbing their hands together with soap.

To attain this, the present invention provides an automatic soap dispenser with notification function which comprises: an outer casing; a soap container which is removably disposed in the outer casing and provided with a pump dispensing means for dispensing liquid soap; a plunger driven by a plunger driving means to move up and down between a default position and a dispensing position where the pump dispensing means is depressed to dispense liquid soap; a plunger position sensor which is configured to be triggered when the plunger is at the default position; and an integrated circuit with timing function which is electrically connected with a switch, a power source, a user sensing means, the plunger position sensor, the plunger driving means and a notification means; and the integrated circuit is programmed to operate in such a way that when the user sensing means is triggered, the integrated circuit activates the plunger driving means and initiates the timing function in order to activate the notification means after a predetermined period of time has elapsed, and when the plunger position sensor is triggered, the integrated circuit deactivates the plunger driving means.

The outer casing comprises a soap container receptacle disposed at a front bottom side thereof, a battery housing disposed at a rear bottom side thereof, and an upper casing which is disposed above the soap container receptacle and the battery housing and receives the plunger and the plunger driving means; the upper casing has a front end which is extended to cover the pump dispensing means of the soap container.

The plunger driving means comprises: horizontal grooves disposed at left side and right side of the upper casing, a motor, a gear set driven by the motor, a driving gear driven by the gear set, a circular disc which is rotatable around the driving gear and rotatably connected to the plunger, and a driving member fixedly disposed on the circular disc and horizontally movable within and along the horizontal grooves. When the plunger driving means is activated to drive the plunger to move downwards, the motor is activated to drive the gear set which in turn drives the driving gear together with the circular disc to rotate along a predetermined direction, and the driving member is thereby driven to move horizontally along the horizontal grooves to drive the plunger to first move downwards until the plunger reaches the dispensing position and thereafter move upwards until the plunger reaches the default position where the plunger position sensor is triggered.

The plunger is an L-shaped box in which the motor, the gear set and the driving gear are disposed. The circular disc is disposed at a front end of the box. The circular disc is disposed at a first side of the box and the first side of the box has a bottom which serves to depress the pump dispensing means of the soap container.

The user sensing means comprises an infrared transmitter and an infrared receiver. The infrared receiver is disposed at the front end of the upper casing of the outer casing, and the infrared transmitter is correspondingly disposed at a front end of the soap container receptacle.

The plunger position sensor is a mechanical micro switch.

The notification means is an LED light and/or a speaker.

The predetermined period of time is the correct period of time required for rubbing hands together with soap in order to thoroughly clean the hands, preferably 10-15 seconds.

The power source is DC power provided by batteries.

The integrated circuit is an 8-bit controller.

The present invention operates as follows:

When the user's hands are positioned underneath the pump dispensing means of the soap container, the user sensing means is triggered. The integrated circuit therefore activates the plunger driving means. Specifically, the motor is first activated to drive the gear set which in turn drives the driving gear together with the circular disc to rotate along a predetermined direction, and the driving member is thereby driven to move horizontally along the horizontal grooves to drive the plunger to move downwards until the plunger reaches the dispensing position to depress the pump dispensing means to dispense liquid soap; at the same time, the motor continues its operation to drive the gear set which in turn drives the driving gear together with the circular disc to rotate along the predetermined direction, and the driving member is thereby driven to move horizontally along the horizontal grooves to drive the plunger to move upwards until the plunger reaches the default position where the plunger position sensor is triggered. After the plunger position sensor is triggered, the integrated circuit deactivates the motor and causes the plunger to remain at the default position.

At the same time when the plunger driving means is activated, the integrated circuit initiates the timing function in order to activate the notification means after a predetermined period of time has elapsed to alert the user that the correct time period for rubbing their hands with soap has elapsed.

In comparison with the prior art, the present invention brings great improvement in promoting hygiene. The present invention can alert the user of the correct time period required for rubbing the hands with soap, thus preventing incomplete cleaning of the hands due to insufficient cleaning time. In addition, the user does not need to touch the soap dispenser, therefore reducing the chances of being infected by germs due to physical contact of the soap dispenser. Moreover, the present invention is simple in structure, small in size and low in production cost, making it very suitable for daily use at home or public washrooms.

### BRIEF DESCRIPTION OF THE DRAWINGS

FIG. 1 shows the perspective view of a preferred embodiment of the present invention.

FIG. 2 shows the circuit diagram of the preferred embodiment of the present invention.

FIG. 3 shows the cross-sectional view of the preferred embodiment of the present invention when the plunger is at the default position.

FIG. 4 shows the cross-sectional view of the preferred embodiment of the present invention when the plunger is between the default position and the dispensing position.

FIG. 5 shows the cross-sectional view of the preferred embodiment of the present invention when the plunger is at the dispensing position.

### DETAILED DESCRIPTION OF THE INVENTION

The present invention is further illustrated by the following non-limiting embodiment and the accompanying drawings.

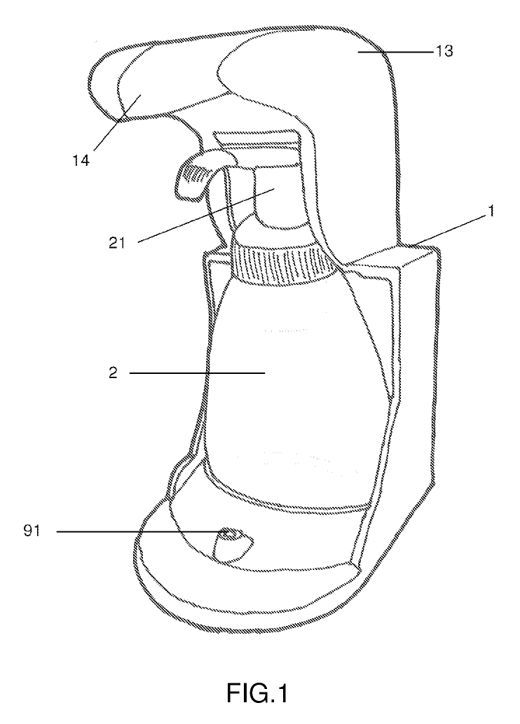

As illustrated in FIGS. 1-3, the automatic soap dispenser with notification function of the present embodiment comprises an outer casing 1, a soap container 2, a plunger 3, a plunger driving means 4, a plunger position sensor 5, an integrated circuit 6, a switch 7, 4 AA batteries 8 which serve as the power source, an infrared transmitter 91 and an infrared receiver 92 which together serve as the user sensing means, and an LED light 101 and a speaker 102 which together serve as the notification means.

The soap container 2 is removably disposed in the outer casing 1 and provided with a pump dispensing means 21 for dispensing liquid soap. The outer casing 1 comprises a soap container receptacle 11 disposed at a front bottom side thereof, a battery housing 12 disposed at a rear bottom side thereof, and an upper casing 13 which is disposed above the soap container receptacle 11 and the battery housing 12 and receives the plunger 3 and the plunger driving means 4. The upper casing has a front end 14 which is extended to cover the pump dispensing means 21 of the soap container. The infrared receiver 92 is disposed at the front end 14 of the upper casing of the outer casing, and the infrared transmitter 91 is correspondingly disposed at a front end of the soap container receptacle 11. The battery housing 12 contains 4 AA batteries 8 which serve as the power source. The 4 AA batteries 8 together provide a DC power of 6V.

The plunger 3 is an L-shaped box in which a motor 42, a gear set 43 and a driving gear 44 are disposed. A circular disc 45 is disposed at a front end of the box. The circular disc 45 is disposed at a first side of the box and the first side of the box has a bottom 31 which serves to depress the pump dispensing means 21. The plunger 3 is driven by the plunger driving means 4 to move up and down between a default position and a dispensing position where the pump depressing means 21 is depressed to dispense liquid soap. The plunger position sensor 5 is a mechanical micro-control switch which is configured to be triggered when the plunger 3 is at the default position.

The plunger driving means 4 comprises horizontal grooves 41 disposed at left and right sides of the upper casing 13, the motor 42, the gear set 43 driven by the motor 42, the driving gear 44 driven by the gear set 43, the circular disc 45 which is rotatable around the driving gear 44 and rotatably connected to the plunger 3, and a driving member 46 fixedly disposed on the circular disc 45 and horizontally movable within and along the horizontal grooves 41.

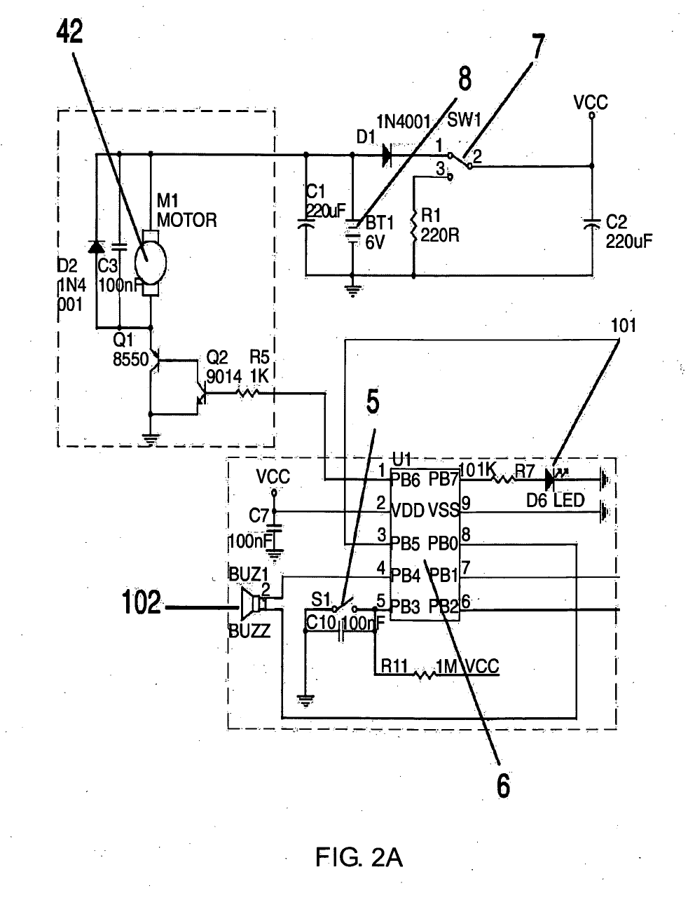

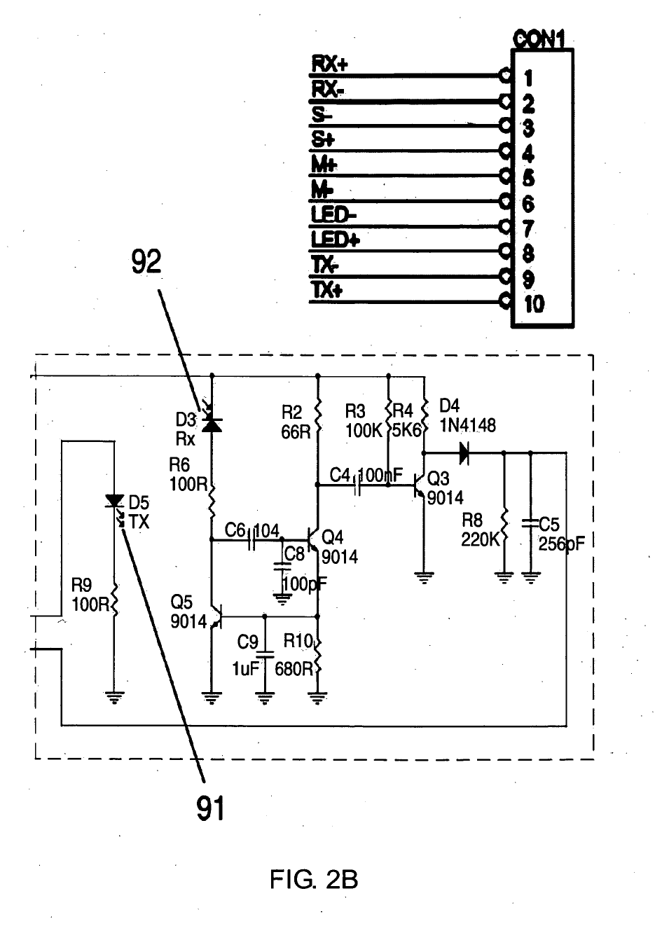

In the present embodiment, the integrated circuit 6 is an 8-bit controller with timing function, and is programmed to operate in such a way that when the infrared transmitter 91 and the infrared receiver 92 which together serve as the user sensing means is triggered, the integrated circuit 6 activates the plunger driving means 4 and initiates the timing function in order to activate the LED light 101 and the speaker 102 which together serve as the notification means after a predetermined period of time has elapsed; and when the plunger position sensor 5 is triggered, the integrated circuit deactivates the plunger driving means 4. In the present embodiment, the predetermined period of time is 15 seconds, which is the correct period of time required for rubbing hands together with soap in order to thoroughly clean the hands. As illustrated in FIG. 2, the VSS end connects to the ground, the VDD end connects to the batteries 8 which serve as the power source, the input ends PB2, PBS, PB3 connect to the infrared receiver 92 and the plunger position sensor 5 respectively, the output ends PB6, PB7, PB4, PB0, PB1 connect to the motor 42 of the plunger driving means 4, the LED light 101, the speaker 102 and the infrared transmitter 91 respectively.

The present embodiment operates as follows:

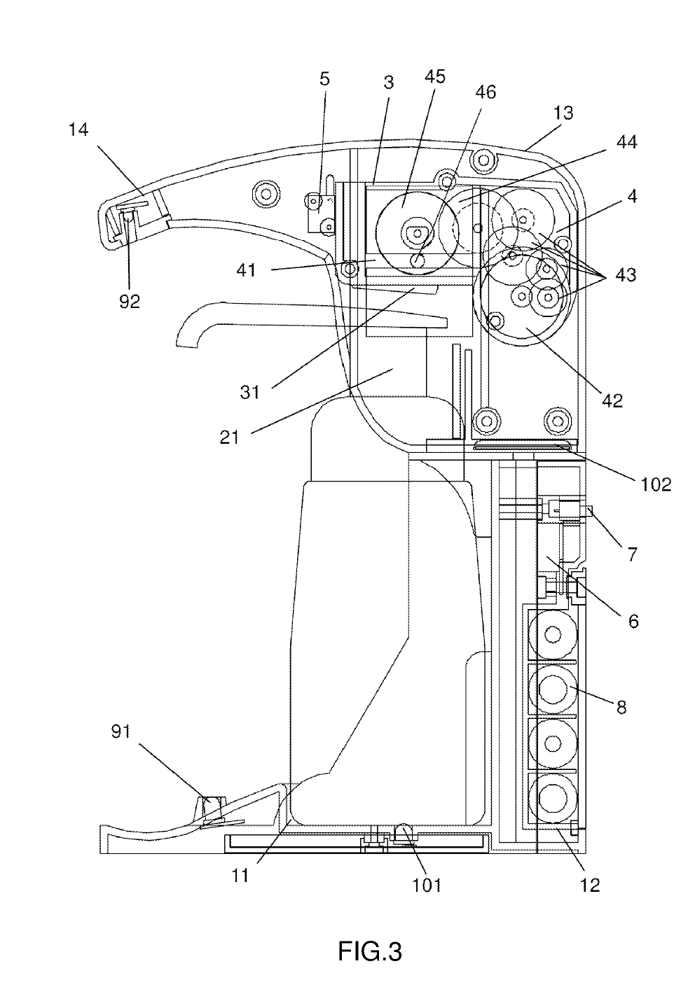

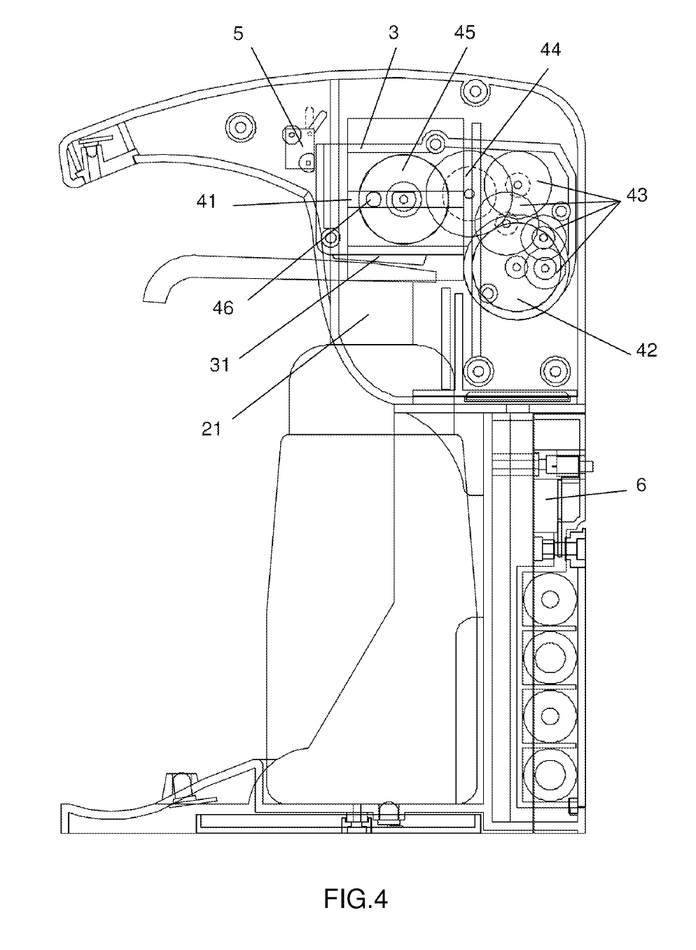

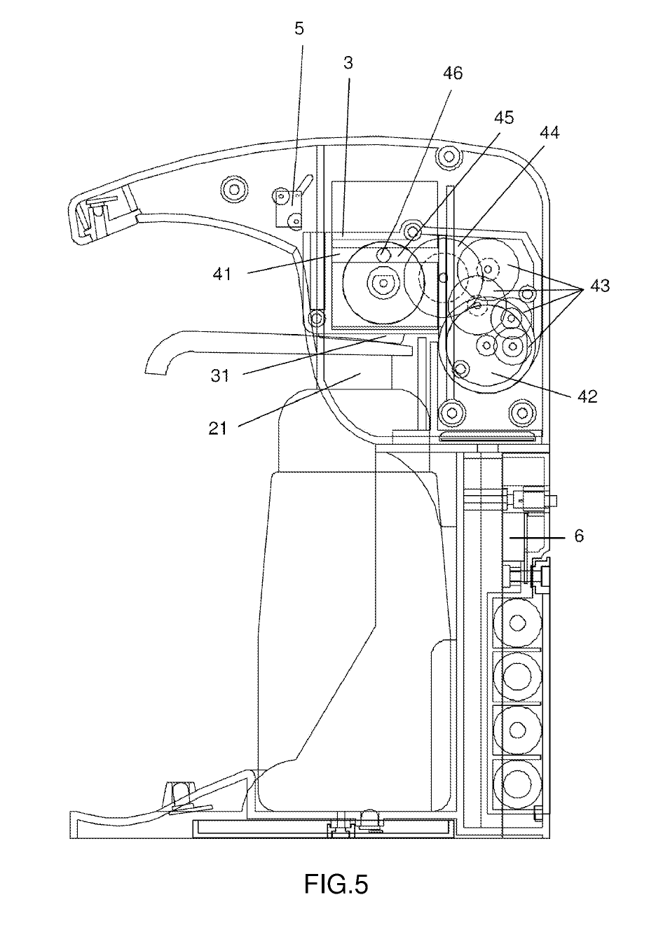

FIG. 3 illustrated the present embodiment when it is not in use, where the plunger is at the default position. When the user's hands are positioned underneath the pump dispensing means 21 of the soap container, the infrared transmitter 91 and the infrared receiver 92 which together serve as the user sensing means is triggered. The integrated circuit 6 therefore activates the motor 42 of the plunger driving means 4 to drive the gear set 43 which in turn drives the driving gear 44 together with the circular disc 45 to rotate along a clockwise direction, and the driving member 46 is thereby driven to move horizontally along the horizontal grooves 41 to drive the plunger 3 to move downwards as illustrated in FIG. 4. When the plunger 3 reaches the dispensing position, the plunger 3 depresses the pump dispensing means 21 to dispense liquid soap as illustrated in FIG. 5. At the same time, the motor 42 continues its operation to drive the gear set 43 which in turn drives the driving gear 44 together with the circular disc 45 to rotate along the clockwise direction, and the driving member 46 is thereby driven to move horizontally along the horizontal grooves 41 to drive the plunger 3 to move upwards until the plunger reaches the default position where the plunger position sensor 5 is triggered. After the plunger position sensor 5 is triggered, the integrated circuit 6 deactivates the motor 42 and causes the plunger 3 to remain at the default position as illustrated in FIG. 3.

At the same time when the motor 42 of the plunger driving means 4 is activated, the integrated circuit 6 initiates the timing function in order to activate the LED light 101 and the speaker 102 which together serve as the notification means after the predetermined time period of 15 seconds has elapsed to alert the user that the correct time period for rubbing their hands with soap has elapsed.

What is claimed is:

1. An automatic soap dispenser with notification function, characterized in that it comprises:
an outer casing;
a soap container which is removably disposed in the outer casing and provided with a pump dispensing means for dispensing liquid soap;
a plunger driven by a plunger driving means to move up and down between a default position and a dispensing position where the pump dispensing means is depressed to dispense liquid soap;
a plunger position sensor which is configured to be triggered when the plunger is at the default position; and
an integrated circuit with timing function which is electrically connected with a switch, a power source, a user sensing means, the plunger position sensor, the plunger driving means and a notification means; and the integrated circuit is programmed to operate in such a way that when the user sensing means is triggered, the integrated circuit activates the plunger driving means and initiates the timing function in order to activate the notification means after a predetermined period of time has elapsed, and when the plunger position sensor is triggered, the integrated circuit deactivates the plunger driving means.

2. The automatic soap dispenser with notification function as in claim 1, characterized in that the outer casing comprises a soap container receptacle disposed at a front bottom side thereof, a battery housing disposed at a rear bottom side thereof, and an upper casing which is disposed above the soap container receptacle and the battery housing and receives the plunger and the plunger driving means; the upper casing has a front end which is extended to cover the pump dispensing means of the soap container.

3. The automatic soap dispenser with notification function as in claim 2, characterized in that the plunger driving means comprises:
horizontal grooves disposed at left side and right side of the upper casing,
a motor,
a gear set driven by the motor,
a driving gear driven by the gear set,
a circular disc which is rotatable around the driving gear and rotatably connected to the plunger, and
a driving member fixedly disposed on the circular disc and horizontally movable within and along the horizontal grooves.

4. The automatic soap dispenser with notification function as in claim 3, characterized in that the plunger is an L-shaped box in which the motor, the gear set and the driving gear are disposed; the circular disc is disposed at a front end of the box; the circular disc is disposed at a first side of the box and the first side of the box has a bottom which serves to depress the pump dispensing means of the soap container.

5. The automatic soap dispenser with notification function as in claim 2, characterized in that the user sensing means comprises an infrared transmitter and an infrared receiver; the infrared receiver is disposed at the front end of the upper casing of the outer casing, and the infrared transmitter is correspondingly disposed at a front end of the soap container receptacle.

6. The automatic soap dispenser with notification function as in claim 1, characterized in that the plunger position sensor is a mechanical micro-control switch.

7. The automatic soap dispenser with notification function as in claim 1, characterized in that the notification means is an LED light and/or a speaker.

8. The automatic soap dispenser with notification function as in claim 1, characterized in that the predetermined period of time is the correct period of time required for rubbing hands together with soap in order to thoroughly clean the hands.

9. The automatic soap dispenser with notification function as in claim 1, characterized in that the predetermined period of time is 10-15 seconds.

10. The automatic soap dispenser with notification function as in claim 1, characterized in that the power source is DC power provided by batteries.
